(19) United States
(12) Patent Application Publication
(10) Pub. No.: US 2014/0038619 A1
(43) Pub. Date: Feb. 6, 2014

(54) WIRELESS COMMUNICATION WITH CO-OPERATING CELLS

(71) Applicant: FUJITSU LIMITED, Kawasaki-shi (JP)

(72) Inventor: Timothy MOULSLEY, Caterham Surrey (GB)

(73) Assignee: FUJITSU LIMITED, Kawasaki-shi (JP)

(21) Appl. No.: 14/048,770

(22) Filed: Oct. 8, 2013

Related U.S. Application Data
(63) Continuation of application No. PCT/EP2011/056670, filed on Apr. 27, 2011.

(51) Int. Cl. H04B 7/02; H04W 84/04

(52) U.S. Cl. CPC H04B 7/02; H04W 84/042
USPC 455/446

(57) ABSTRACT

A wireless communication method including providing one or more base stations each having at least one of multiple sets of antennas, each set of antennas being serving a distinct geographical area; configuring the sets of antennas for use as multiple antenna ports to perform at least data transmission; and receiving, at a subscriber station in wireless communication with at least one base station, a data transmission specific to the subscriber station. The data transmission is jointly transmitted using at least two of the antenna ports with transmit diversity applied between the at least two antenna ports, and at least two of the at least two antenna ports are configured from different ones of the multiple sets of antennas. The antenna ports may correspond to distinct cells and the subscriber station preferably provides separate feedback for each cell.

### CROSS-REFERENCE TO RELATED APPLICATIONS

This application is a continuation application of International Application PCT/EP2011/056670, filed Apr. 27, 2011 and designating the U.S., the entire contents of which are incorporated herein by reference.

### FIELD OF THE INVENTION

The present invention relates to wireless communication systems, for example systems based on the 3GPP Long Term Evolution (LTE) and 3GPP LTE-A groups of standards.

### BACKGROUND

Wireless communication systems are widely known in which base stations (BSs) communicate with user equipments (UEs) (also called subscriber or mobile stations) within range of the BSs.

The geographical area covered by a base station is generally referred to as a cell, and typically many BSs are provided in appropriate locations so as to form a network covering a wide geographical area more or less seamlessly with adjacent and/or overlapping cells. (In this specification, the terms “system” and “network” are used synonymously). In more advanced systems, the concept of a cell can also be used in a different way: for example to define a set of radio resources (such as a given bandwidth around a carrier centre frequency), with an associated identity which may be used to distinguish one cell from another. The cell identity can be used for example in determining some of the transmission properties of communication channels associated with the cell, such as using scrambling codes, spreading codes and hopping sequences. A cell may also be associated with one or more reference signals (see below), which are intended to provide amplitude and/or phase reference(s) for receiving one or more communication channels associated with the cell. Therefore, it is possible to refer to communication channels associated with a cell being transmitted from or by the cell (in the downlink), or transmitted to a cell (in the uplink), even if the transmission or reception is actually carried out by a base station. Typically, in an FDD system, a downlink cell is linked or associated with a corresponding uplink cell operating at a different frequency. However, it should be noted that it would in principle be possible to organise a communication system which has cell-like features without explicit cells being defined. For example, an explicit cell identity may not be needed in all cases.

Each BS divides its available bandwidth, i.e. frequency and time resources in a given cell, into individual resource allocations for the user equipments which it serves. The user equipments are generally mobile and therefore may move among the cells, prompting a need for handovers of radio communication links between the base stations of adjacent cells. A user equipment may be in range of (i.e. able to detect signals from) several cells at the same time, but in the simplest case it communicates with one “serving” cell. For some purposes a BS may also be described as an “access point” or a “transmission point”. In LTE, one kind of base station is referred to as an eNodeB. As is well-known, LTE is a frame-based OFDM system in which the frequency and time resources are configured within “frames” each having at least one downlink subframe and uplink subframe. These may be either consecutive (Time Division Duplexing or TDD) or simultaneous (Frequency Division Duplexing or FDD).

Each eNodeB may have multiple sets of antennas (e.g. with 2 or 4 antennas per set), allowing it to serve multiple cells at the same frequency simultaneously. A common configuration is for a single eNodeB to be equipped with three sets of physical antennas for covering three adjacent cells. The physical antennas for a given cell typically have the same antenna patterns and are physically mounted to point in the same direction (to define the coverage area of the cell).

Moreover, there may be distinct uplink and downlink cells (in the remainder of this specification, the term “cell” can be assumed to mean at least a downlink cell). Incidentally, the wireless network is referred to as the “E-UTRAN” (Evolved UMTS Terrestrial Radio Access Network) in LTE. The eNodeBs are connected to each other, and to higher-level nodes, by a backhaul network, e.g. the core network or Evolved Packet Core (EPC).

To facilitate measurements of the radio link properties by UEs, and reception of some transmission channels, reference signals are embedded in the downlink sub-frame as transmitted from each antenna of an eNodeB or more correctly, “antenna port”. The term “antenna port” is preferred when referring to transmissions from multiple antennas, since it is possible for multiple physical antennas to transmit copies of the same signal and thus act as a single antenna port. More precisely, an antenna port is formed by applying a set of precoding weights to set of physical antennas.

In LTE, an antenna port is defined with respect to a distinct reference signal configuration, but it should be noted that this is not essential for the present invention to be described. It should be noted that the same physical antenna can be used in multiple antenna ports at once, allowing multiple “layers” of transmission. To achieve this, the signals corresponding to different antenna ports are superimposed at the physical antennas.

Typically, in the case of two transmit antenna ports in LTE, therefore, reference signals are transmitted from each antenna port. The reference symbols for different antenna ports are arranged to be orthogonal (in time/frequency and/or code domain) to allow UEs to accurately measure the corresponding radio link properties or derive an amplitude and/or phase reference.

The reference signals can provide an amplitude and/or phase reference for allowing the UEs to correctly decode the remainder of the downlink transmission. In LTE, reference signals include a cell-specific (or common) reference signal (CRS), and a UE-specific demodulation reference signal (DMRS).

The CRS is transmitted to all the UEs within a cell and used for channel estimation. The reference signal sequence, which spans the entire downlink cell bandwidth, depends on, or implicitly carries, the cell identity or “cell ID”. As a cell may be served by an eNodeB having more than one antenna port, respective CRS may be provided for up to four antenna ports and the locations of CRSS depend on the antenna port. The number and location of CRSS depends not only on the number of antenna ports but also on which type of CP is in use.

The UE-specific reference signal (DMRS) is received by a specific UE or a specific UE group within a cell. UE-specific reference signals are chiefly used by a specific UE or a specific UE group for the purpose of data demodulation.

CRSS can be accessed by all the UEs within the cell covered by the eNodeB regardless of the specific time/frequency resource allocated to the UEs. They may be used by UEs to measure properties of the radio channel—so-called channel state information or CSI—with respect to such parameters as a Channel Quality Indicator, CQI.

LTE-A (LTE-Advanced) introduces further reference signals including a Channel State Information reference signal CSI-RS. (Incidentally, references henceforth to LTE are to be taken to include LTE-A except where the distinction is clear from the context). These additional signals have particular application to beamforming and MIMO transmission techniques outlined below.

Further details of reference signals and MIMO techniques used in LTE are given in the specification document 3GPP TS36.211, hereby incorporated by reference.

Several channels for data and control signalling are defined at various levels of abstraction within the network. FIG. 1 shows some of the channels defined in LTE at each of a logical level, transport layer level and physical layer level, and the mappings between them. For present purposes, the channels at the physical layer level are of most interest.

On the downlink, user data is carried on the Physical Downlink Shared Channel (PDSCH). There are various control channels on the downlink, which carry signalling for various purposes, and also messages for so-called Radio Resource Control (RRC) and Radio Resource Management (RRM). In addition there are various physical control channels in the downlink, in particular the Physical Downlink Control Channel (PDCCH) (see below).

Meanwhile, on the uplink, user data and also some signalling data is carried on the Physical Uplink Shared Channel (PUSCH), and control channels include a Physical Uplink Control Channel, PUCCH, used to carry signalling from UEs including channel quality indication (CQI) reports, precoding matrix information (PMI), a rank indication for MIMO (see below), and scheduling requests.

Neighbouring cells are typically given different cell IDs, which can be used as a basis for distinguishing transmissions from different cells; for example, data transmissions are scrambled by sequences which depend on the cell ID. The locations of the common reference symbols (CRS) in the frequency domain also depend on the cell ID. In practice neighbouring cells must have different cell IDs. One reason for this is so that the CRS occupy different locations, otherwise channel measurements for the different cells are using CRS are not feasible if the OFDM symbols for CRS happen to be aligned in the time domain. The resources used by channels such as PDSCH, PDCCH, PCFICH, and PHICH depend on cell ID. PDCCH is used to carry scheduling information—called downlink control information, DCI—from eNodeBs to individual UEs.

Various MIMO transmission techniques, where MIMO stands for multiple-input multiple-output, are adopted in LTE due to their potential for spectral efficiency gain, spatial diversity gain and antenna gain. One such technique is so-called transmit (Tx) diversity, where blocks of data intended for the same UE are transmitted via multiple transmitting antenna ports, the signals from which may follow different propagation paths.

A number of MIMO modes are defined in LTE, some of which are schematically illustrated in FIGS. 2A to 2E and briefly outlined as follows.

FIG. 2A: single antenna port (labelled Port 0). The non-MIMO case of transmitting data to one UE 20 from a single antenna at the base station 10 (eNodeB).

FIG. 2B: transmit diversity in which the same information is transmitted from different antennas at the base station 10. The information is coded differently on each antenna by using Space Frequency Block Coding (SFBC) as outlined below, so as to transmit symbols carrying the same data on different subcarriers from each antenna. Only one receiving antenna port (Rx antenna) is needed at the UE 20, although two or more Rx antennas may be used to improve performance.

FIG. 2C: Open-Loop spatial multiplexing. Two information streams, also called “spatial layers” (and below referred to simply as layers), are transmitted over 2 or 4 antennas without the UE 20 providing explicit feedback (hence, “open-loop”). A Transmit Rank Indication (TRI) is transmitted by the base station 10 to inform the UE 20 of the number of spatial layers. A related technique (not illustrated) is Closed-Loop spatial multiplexing, where the UE provides feedback in the form of a Precoding Matrix Indicator (PMI). This allows the base station to precode the data to be transmitted to optimize transmission by selecting the best set of precoding weights (precoding matrix) from a number of predetermined candidates in a so-called “codebook”.

FIG. 2D: Multi-User MIMO: similar to Closed-Loop spatial multiplexing except that now the information streams are directed to different UEs 21 and 22, the number of which is limited by the number of spatial layers (up to one user per spatial layer).

FIG. 2E: Beamforming. In this mode, a single code word is transmitted over a single spatial layer, the antennas co-operating to provide directivity of the transmission beam towards a specific UE 20. Thus from the UE's perspective, the transmission appears like a single beam from a single virtual antenna. DMRS is used which allows the UE 20 to estimate the channel after precoding as already mentioned, for example, the specific pattern of DMRS defining a so-called “antenna port 5”.

Variations of the above MIMO techniques are possible. LTE-A provides additional transmission modes with the further reference signals mentioned earlier, which allow beamforming with multiple layers for example.

Usage of the above transmission modes will depend not only on the system implementation but also on the prevailing geographical conditions including multipath (signal scattering), and mobility of users. For users at a cell edge, for example, transmit diversity will be particularly useful. Transmit diversity is also a robust technique for use with rapidly-moving UEs. Where multipath is low, for example in rural areas, beamforming in accordance with FIG. 2E will be useful. By contrast, in multipath-rich environments the spatial multiplexing techniques become attractive.

Related to the above, it is a known possibility to coordinate the MIMO transmissions among multiple cells (i.e. coordinating transmissions in adjacent or nearby cells) to reduce inter-cell interference and improve the data rate to a given UE. This is called coordinated multi-point transmission/reception or CoMP. One form of CoMP suitable for the downlink is called Joint Processing/Joint Transmission (JP/JT).

In JP/JT, data to a single UE is simultaneously transmitted from multiple cells to (coherently or non-coherently) improve the received signal quality and/or cancel interference for other UEs. In other words the UE actively communicates in multiple cells at the same time. Where the cells are provided by different eNodeBs, it is necessary for them to share the user data via the backhaul network. From the viewpoint of the UE, it makes no difference whether the cells belong to different eNodeBs or to the same eNodeB. Thus, JP/JT could be performed with cells provided by the same eNodeB.

The above techniques involve various stages of signal processing at the eNodeB(s), including layer mapping and precoding. FIG. 3 shows a signal generation chain for downlink transmission signals in an LTE system.

The first stage 12, scrambling, refers scrambling the bits in each of the code words 11 to be transmitted on a physical channel. The Modulation mapper 13 converts the scrambled bits into complex-valued modulation symbols. The Layer mapper 14 assigns (or maps) the complex-valued modulation symbols onto one or more “layers” 15 for transmission. Precoding 16, of a kind dependent on the antenna port used for each layer, is then applied to the complex-valued modulation symbols. The Resource el. mapper 17 maps the symbols for each antenna port onto so-called “resource elements” which are basic units for allocation of data within the frame. Finally, an OFDM modulator 18 converts the symbols into complex-valued time-domain OFDM signals for each antenna port 19.

Incidentally, the above-mentioned DMRS and CRS are introduced in the signal chain before and after Precoder 16, respectively. Thus the DMRS is precoded by the same Precoder 16 as employed on the data, for assisting the UE in demodulating the data.

The purpose of precoding is to distribute the modulated data symbols over the transmit antennas whilst (if possible) taking channel conditions into account. Space Time Block Coding (STBC) and Space Frequency Block Coding (SFBC) are two examples of possible coding methods. These methods are particularly suited to “open loop” diversity schemes since the transmitters do not have perfect knowledge of the transmission channel. Briefly the distinction between these methods is that in STBC, coding is applied across the time domain, so that the data can be recovered at the receiver by decoding symbols which are adjacent in time, whereas in SFBC, coding is applied across the frequency domain so the data can be recovered at the receiver by decoding symbols which are in adjacent subcarriers.

In LTE, basic STBC/SFBC is applied to two antenna ports; in the case of four transmit antenna ports it is necessary to combine it with Frequency Shift Transmit Diversity (FSTD) or Time Shift Transmit Diversity (TSTD) so as to perform switching of symbols across the antenna ports either in frequency (subcarrier) or in time. SFBC-TSTD has been selected as the 4-port precoding technique in LTE-A.

Another precoding technique, used in transmit diversity for example, is Cyclic Delay Diversity or CDD. This precoding causes “delayed” versions (either in time or in frequency) of the same OFDM symbol to be transmitted from each antenna of a set of antennas, effectively introducing artificial multipath into the signals received at the UE. Large-delay CDD is used in the above-mentioned Open-Loop spatial multiplexing for example.

In conventional multi-cellular networks, the spectral efficiency of downlink transmission is limited by the inter-cell interference. One approach to this problem is to coordinate the transmissions among multiple cells (which may imply multiple base stations) as already mentioned, in order to mitigate the inter-cell interference. As a result of the coordination (COMP), the inter-cell interference can be reduced or eliminated among the coordinated cells, resulting in a significant improvement in the coverage of high data rates, the cell-edge throughput and/or system throughput.

Currently in LTE, at a given carrier frequency a single data channel (PDSCH) is transmitted to the UE from one serving cell (the primary cell or Pcell). For a UE at the cell border the transmissions from the Pcell suffer from increased interference from neighbouring cells operating at the same frequency and typically a lower effective transmission rate is used to increase robustness to such interference. This is can be achieved by lowering the code rate and/or repeating the message. Both approaches require more transmission resources.

For at least some UEs (e.g. at the cell border) it would be beneficial to be able to jointly transmit the same PDSCH message from two cells. This would greatly improve the SINR for such a message, which could allow a higher data rate.

To achieve joint transmission of PDSCH from different cells would require that radio frames are time-aligned, so that the PDCCH regions overlap. This would also mean that the CRS symbols overlap in the time domain, so different cell IDs becomes essential to allow different locations in the frequency domain. Therefore, the resources required for CRS and hence PDSCH are in principle different between the different cells. Therefore, even with aligned radio frames, in general, slightly different resources are used for two otherwise identical PDCCH messages in different cells.

### SUMMARY

According to a first aspect of the present invention, there is provided a wireless communication system having: one or more base stations each having at least one of a plurality of sets of antennas, each set of antennas being capable of serving a distinct geographical area and each set of antennas being capable of being configured for use as a plurality of antenna ports; and a subscriber station in wireless communication with at least one base station for receiving a data transmission specific to the subscriber station; wherein the data transmission is jointly transmitted using at least two antenna ports with transmit diversity applied between the at least two antenna ports, and at least two of the at least two antenna ports being configured from different ones of the plurality of sets of antennas.

In the present invention, the term “antenna port” refers to a set of antennas (physical antennas) to which a set of precoding weights (in other words a precoding matrix) is applied. The same physical antenna may belong to more than one of the sets of antennas. The geographical areas served by the different sets of antennas will be distinct but overlapping, such that a given subscriber station may be in wireless communication with multiple sets of antennas at once. Each antenna port may be associated with a distinct reference signal for reception by the subscriber station.

Preferably, at least one of the sets of antennas corresponds to a cell. Thus, the distinct geographical areas referred to above may correspond to respective cells, and the subscriber station may be in wireless communication with a plurality of cells, in which case, preferably, the subscriber station is arranged to provide separate feedback for each cell. As mentioned in the introduction, the term “cell” in this specification is to be interpreted broadly. For example, it is possible to refer to communication channels associated with a cell being transmitted from or by the cell (in the downlink), or transmitted to a cell (in the uplink), even if the transmission or reception is actually carried out by a base station. The term “cell” is intended also to include sub-cells.

The cells may be associated with different base stations or with the same base station. The term “base station” itself has a broad meaning and encompasses, for example, an access point or transmission point. The invention is applicable to cells with the same carrier frequency, or with overlapping frequency ranges. Preferably also, but not essentially, these cells have different cell IDs.

Also, a plurality of the antenna ports may correspond to the same cell. That is, a given set of antennas may be configured as multiple antenna ports so as, for example, to provide multi-layer (multi-beam) transmission in a given cell.

The plurality of sets of antennas may be provided by the same base station. On the other hand, the plurality of sets of antennas may be provided by two or more base stations. Any permutation is possible: for example one base station could contribute two sets of antennas whilst two other base stations each provide one set of antennas. As already mentioned, there may be some overlap among the antennas employed in the sets of antennas.

The above methods include the case of performing data transmission in more than one layer. Thus, in another embodiment the data transmission includes a plurality of layers each formed by at least two of the antenna ports, different antenna ports being used for each layer. A further possible configuration would involve two antenna ports from one cell (set of antennas) and one port from another cell.

As already mentioned the data transmission is jointly transmitted with transmit diversity applied between the two antenna ports. However beamforming may also be applied in one or more of the antenna ports.

In one embodiment the system is an LTE-based system, the or each base station is an eNodeB, and the transmit diversity is a transmission mode specified in LTE and/or LTE-A. In this case the data transmission specific to the subscriber station may be carried on the Physical Downlink Shared CHannel (PDSCH) of the LTE-based system.

In a case where the subscriber station receives reference signals as already mentioned, these may include, in the case of such an LTE-based system, a CRS or DMRS specified in LTE and/or LTE-A.

According to a second aspect of the present invention, there is provided a base station for use in any wireless communication method defined above, and configured to provide at least one of the antenna ports for the jointly transmitted data transmission.

According to a third aspect of the present invention, there is provided a subscriber station for use in any wireless communication method as defined above, configured to receive the joint data transmission from the at least two antenna ports.

According to a further aspect of the present invention, there is provided a wireless communication method comprising:

providing one or more base stations each having at least one of a plurality of sets of antennas, each set of antennas being serving a distinct geographical area;

configuring the sets of antennas for use as a plurality of antenna ports to perform at least data transmission; and

receiving, at a subscriber station in wireless communication with at least one base station, a data transmission specific to the subscriber station; wherein

the data transmission is jointly transmitted using at least two of the antenna ports with transmit diversity applied between the at least two antenna ports, and at least two of the at least two antenna ports being configured from different ones of the plurality of sets of antennas.

The above method may have any of the preferred features already mentioned with respect to the wireless communication system.

A further aspect relates to software for allowing transceiver equipment equipped with a processor to provide a base station equipment or subscriber station as defined above. Such software may be recorded on a computer-readable medium.

Thus, embodiments of the present invention can allow two or more sets of antennas to jointly transmit a data channel to the same UE by contributing, in the simplest case, one different antenna port each. The sets of antennas serve distinct geographical areas and may therefore be regarded as providing distinct “cells”. The UE preferably provides independent feedback reports to each cell, which is facilitated by the use of distinct reference signals for the antenna ports. This avoids the need for knowledge of the combined channel at the base station(s) providing the sets of antennas.

This differs from known joint transmission techniques such as CoMP in that in known CoMP, all antennas are used for beamforming whereas in the present invention, distinct antenna ports are employed, and these are used to provide transmit diversity.

This concept can be extended by allowing each set of antennas to contribute a second, or further, antenna port; this corresponds to a second or further “layer” of MIMO transmission. In the case of each second or further antenna port, this should preferably be different from each other and from the antenna ports used for the first layer.

In general, and unless there is a clear intention to the contrary, features described with respect to one aspect of the invention may be applied equally and in any combination to any other aspect, even if such a combination is not explicitly mentioned or described herein.

As is evident from the foregoing, the present invention involves signal transmissions between base stations and subscriber stations in a wireless communication system.

Sets of antennas, configured for use as a plurality of antenna ports, are associated with one or more base stations. A base station may take any form suitable for transmitting and receiving such signals. It is envisaged that the base stations will typically take the form proposed for implementation in the 3GPP LTE and 3GPP LTE-A groups of standards, and may therefore be described as an eNodeB (eNB) (which term may also embrace Home eNodeB or Home eNodeB in certain situations). However, subject to the functional requirements of the invention, some or all base stations may take any other form suitable for transmitting and receiving signals from user equipments.

Similarly, in the present invention, each subscriber station may take any form suitable for transmitting and receiving signals from base stations, and may be mobile or fixed. In LTE, subscriber stations are referred to as UEs. For the purpose of visualising the invention, it may be convenient to imagine each UE as a mobile handset (and in many instances at least some of the subscriber stations will comprise mobile handsets), however no limitation whatsoever is to be implied from this.

### BRIEF DESCRIPTION OF THE DRAWINGS

Reference is made, by way of example only, to the accompanying drawings in which:

FIG. 1 shows relationships between various channels defined in LTE;

FIG. 2A illustrates non-MIMO transmission from an antenna port of a base station to a UE;

FIG. 2B illustrates transmit diversity as one possible MIMO transmission technique;

FIG. 2C illustrates open-loop spatial multiplexing as another MIMO transmission technique;

FIG. 2D illustrates multi-user MIMO in which multiple antenna ports at a base station communicate simultaneously with multiple UEs;

FIG. 2E illustrates beamforming, in which multiple antenna ports co-operate to jointly transmit a transmission signal to a single UE, as a further MIMO transmission technique;

FIG. 3 illustrates the signal processing chain for downlink transmission signals in an eNodeB;

FIG. 4 illustrates transmit diversity as performed in an embodiment of the present invention; and

FIG. 5 is a flowchart of steps in a wireless communication method embodying the present invention.

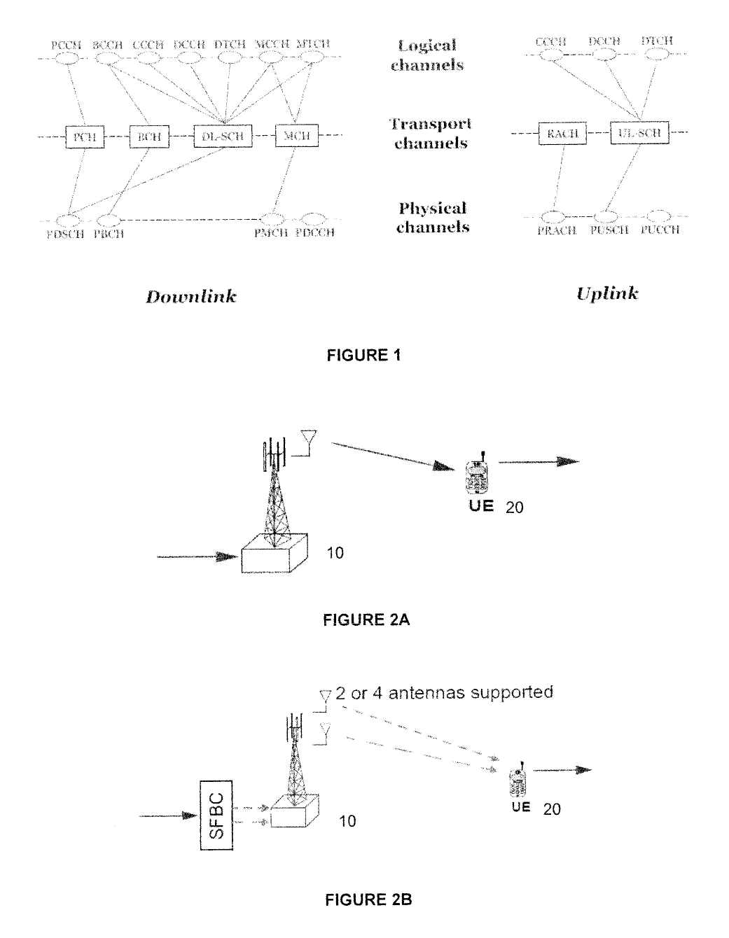

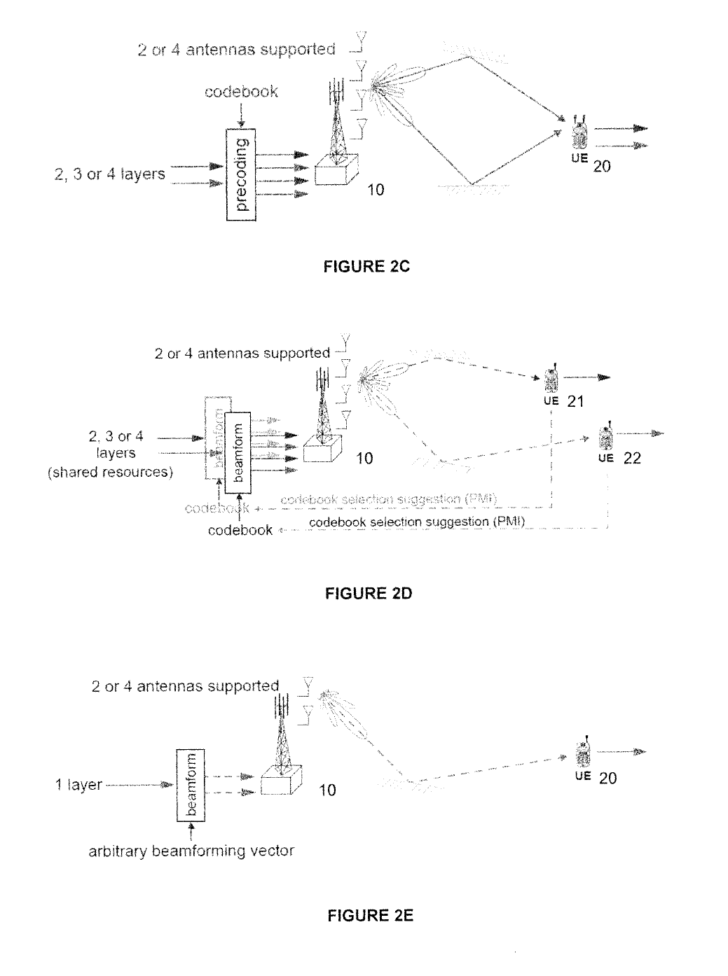

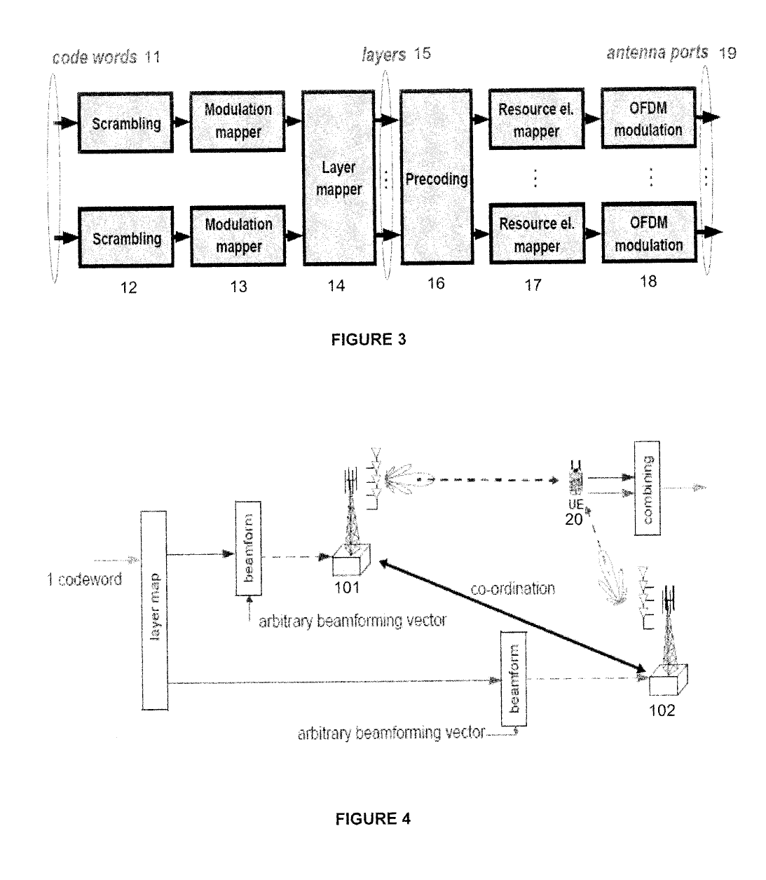

### DETAILED DESCRIPTION

Before describing an embodiment of the present invention, some specific detail regarding MIMO transmission techniques in LTE will first be given.

Various MIMO transmission schemes are possible in an LTE-based wireless communication system, as already outlined in the introduction, and as mentioned reference signals may be used to allow the UEs to measure the channel and provide feedback to the base station. For schemes based on CRS a phase/amplitude reference for each antenna port is derived from a linear combination of common reference signals. Another possibility, for schemes based on DMRS, is to provide the receiver with a dedicated reference signal for each port.

More details of a couple of schemes used in LTE are provided below:—Precoding for spatial multiplexing using antenna ports with UE-specific reference signals (from the above-mentioned 3GPP TS36.211)

Precoding for spatial multiplexing using antenna ports with UE-specific reference signals is only used in combination with layer mapping for spatial multiplexing as described in Section 6.3.3.2. Spatial multiplexing using antenna ports with UE-specific reference signals supports up to eight antenna ports and the set of antenna ports used is p=7, 8, . . . , ν+6. For transmission on ν antenna ports, the precoding operation is defined by

$$[ \begin{matrix}{y}^{( 7 )} ( i ) \\ {y}^{( 8 )} ( i ) \\ ⋮ \\ {y}^{( 6 + υ )} ( i )\end{matrix} ] = [ \begin{matrix}{x}^{( 0 )} ( i ) \\ {x}^{( 1 )} ( i ) \\ ⋮ \\ {x}^{( υ - 1 )} ( i )\end{matrix} ]$$

where i=0, 1, . . . m_{symb}^{ap}−1, M_{symb}^{ap}=m_{symb}^{layer}.

The mapping between antenna ports and physical antennas can be illustrated by the following:

$$[ \begin{matrix}{z}^{( p , 0 )} ( i ) \\ {z}^{( p , 1 )} ( i ) \\ ⋮ \\ {z}^{( p , N w - 1 )} ( i )\end{matrix} ] = {y}^{( p )} ( i ) [ \begin{matrix}{w}^{( p , 0 )} ( i ) \\ {w}^{( p , 1 )} ( i ) \\ ⋮ \\ {w}^{( p , N w - 1 )} ( i )\end{matrix} ]$$

Where y^{(p)}(i) is the symbol to be transmitted on an antenna port p, w(i) are the precoding coefficients for each physical antenna for antenna port p, Nw is the number of physical antennas and z(i) are the transmitted symbols from each physical antenna for antenna port p.

The transmission from each antenna ports corresponds to a spatial multiplexing (up to 8 layers in LTE).

Precoding for transmit diversity (from 3GPP TS36.211)

Precoding for transmit diversity is only used in combination with layer mapping for transmit diversity as described in Section 6.3.3.3. The precoding operation for transmit diversity is defined for two and four antenna ports.

For transmission on two antenna ports, p ε{0, 1}, the output y(i)=[y⁽⁰⁾₍ᵢ₎ y⁽¹⁾₍ᵢ₎]^{T}, i=0, 1, . . . , M_{symb}^{ap}−1 of the precoding operation is defined by

$$[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ]$$

for i=0, 1, . . . , M_{symb}^{layer}−1 with M_{symb}^{ap}=2M_{symb}^{layer}.

For transmission on four antenna ports, p ε{0, 1, 2, 3}, the output y(i)=[y⁽⁰⁾₍ᵢ₎ y⁽¹⁾₍ᵢ₎ y⁽²⁾₍ᵢ₎ y⁽³⁾₍ᵢ₎]^{T}, i=0, 1, . . . , M_{symb}^{ap}−1 of the precoding operation is defined by

$$[ \begin{matrix}{y}^{( 0 )} ( 4 i ) \\ {y}^{( 1 )} ( 4 i ) \\ {y}^{( 2 )} ( 4 i ) \\ {y}^{( 3 )} ( 4 i ) \\ {y}^{( 0 )} ( 4 i + 1 ) \\ {y}^{( 1 )} ( 4 i + 1 ) \\ {y}^{( 2 )} ( 4 i + 1 ) \\ {y}^{( 2 )} ( 4 i + 1 ) \\ {y}^{( 0 )} ( 4 i + 2 ) \\ {y}^{( 1 )} ( 4 i + 2 ) \\ {y}^{( 2 )} ( 4 i + 2 ) \\ {y}^{( 3 )} ( 4 i + 2 ) \\ {y}^{( 0 )} ( 4 i + 3 ) \\ {y}^{( 1 )} ( 4 i + 3 ) \\ {y}^{( 2 )} ( 4 i + 3 ) \\ {y}^{( 3 )} ( 4 i + 3 )\end{matrix} ] = \frac{1}{\sqrt{2}} [ \begin{matrix}1 & 0 & 0 & 0 & j & 0 & 0 & 0 \\ 0 & 0 & 0 & 0 & 0 & 0 & 0 & 0 \\ 0 & - 1 & 0 & 0 & 0 & j & 0 & 0 \\ 0 & 0 & 0 & 0 & 0 & 0 & 0 & 0 \\ 0 & 1 & 0 & 0 & 0 & j & 0 & 0 \\ 0 & 0 & 0 & 0 & 0 & 0 & 0 & 0 \\ 1 & 0 & 0 & 0 & - j & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 1 & 0 & 0 & 0 & j & 0 \\ 0 & 0 & 0 & 0 & 0 & 0 & 0 & 0 \\ 0 & 0 & 0 & - 1 & 0 & 0 & 0 & j \\ 0 & 0 & 0 & 0 & 0 & 0 & 0 & 0 \\ 0 & 0 & 0 & 1 & 0 & 0 & 0 & j \\ 0 & 0 & 0 & 0 & 0 & 0 & 0 & 0 \\ 0 & 0 & 1 & 0 & 0 & 0 & - j & 0\end{matrix} ] [ \begin{matrix}Re ( {x}^{( 0 )} ( i ) ) \\ Re ( {x}^{( 1 )} ( i ) ) \\ Re ( {x}^{( 2 )} ( i ) ) \\ Re ( {x}^{( 3 )} ( i ) ) \\ Im ( {x}^{( 0 )} ( i ) ) \\ Im ( {x}^{( 1 )} ( i ) ) \\ Im ( {x}^{( 2 )} ( i ) ) \\ Im ( {x}^{( 3 )} ( i ) )\end{matrix} ]$$

$$for i = 0 , 1 , … , {M}_{symb}^{layer} - 1 with {M}_{symb}^{ap} = \{ \begin{matrix}4 {M}_{symb}^{layer} & if {M}_{symb}^{( 0 )} mod 4 = 0 \\ ( 4 {M}_{symb}^{layer} ) - 2 & if {M}_{symb}^{( 0 )} mod 4 \neq 0\end{matrix} .$$

For a single antenna at the receiver and two antenna ports at the transmitter the received symbols are s(2i) and s(2i+1), given by:

$$[ \begin{matrix}s ( 2 i ) \\ s ( 2 i + 1 )\end{matrix} ] = [ \begin{matrix}{h}^{( 0 )} & {h}^{( 1 )} & 0 & 0 \\ 0 & 0 & {h}^{( 0 )} & {h}^{( 1 )}\end{matrix} ] [ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ]$$

Where h(0) and h(1) represent the transfer functions of the radio channel between each transmit antenna port and the receiver. It is assumed that these channels do not change between time 2i and 2i+1, and that the coefficients are known perfectly at the receiver. Under these assumptions, and ignoring the effects of noise, each of the transmitted symbols x⁽⁰⁾(i) and x⁽ⁱ⁾(i) can be derived exactly by a different linear combination of the received symbols. In practice channel estimation errors (e.g. in measurements derived from reference symbols), channel changes with time and receiver noise will mean that the transmitted signals can only be estimated.

As already mentioned it would be desirable to jointly transmit the same PDSCH from two cells.

For consideration of this problem we assume two cooperating cells controlled by a single eNodeB and that transmission is based on the use of DMRS for demodulation, the same system bandwidth and a similar antenna configuration in both cells. A possible approach to solving the problem is to transmit two copies of a PDSCH each from the two cooperating cells. These would be transmitted with identical message contents and transmission format but not necessarily with any other special measures to ensure successful reception. There would be at least the following issues to deal with.
The DMRS from the two cells would either both need to be received by the UE (i.e. transmitted in different resources), or transmitted in the same resources in order to allow a combined channel estimate to be derived.
For receiving both sets of DMRS the UE would need to be aware of the possibility that two cells were transmitting PDSCH with the same contents. This could be indicated by Radio Resource Control (RRC) signalling.
Joint transmission based on joint precoding would require some knowledge of the combined channel matrix at the eNodeB. This could be achieved for example by feedback from the UE, either on the basis of a single channel matrix for both cells, or independent feedback reports for the two cells, together with some inter-cell information (in particular inter-cell phase).

The inter-cell phase difference at the UE receiver would be required to be known at the eNodeB, and this depends primarily on the difference in length of the propagation paths from the two cells to the UE. Typically (at least for FDD) this phase difference would need to be measured by the UE signalled from the UE to the eNodeB. Alternatively or additionally the UE could measure and report the time difference directly. Such reports would increase the uplink signalling overhead.

We note that in general it is desirable to minimise the feedback overhead from the UE.

An important feature of the invention is based on the recognition that joint transmission by cooperating cells (or access points) can be provided where each antenna port is associated with a particular cell. This has the advantage that the precoding (beamforming) for the physical antennas at each cell can be designed in separate consideration of the channel characteristics at that cell. Where precoding is jointly designed for more than one cell this approach also has the advantage that inter-cell phase information is not required.

Note that the term “cell” is used for convenience, as a label for a geographical area served by a set of physical antennas. As already mentioned each set of antennas may be configured as various kinds of antenna port, possibly simultaneously. Thus a “cell” is distinct from an “antenna port”.

Although it is not essential for each such cell to have a unique cell ID, in the context of the invention a cell can be considered as having a distinct identity, and serving a particular geographic area over a particular frequency range. The different cells considered by the invention need to have distinct (but overlapping) geographic coverage areas. For the purposes of the invention the identities could be the same or different and frequency ranges should be the same, or more precisely, at least part of the frequency ranges of the cells need to overlap.

Therefore with this approach of separate antenna ports per cell and using independent feedback reports for the two cells but without inter-cell phase information, joint beamforming can still be performed by the two cells. In addition transmit diversity across the antenna ports from different cells is feasible.

For example, using the following equation to implement SFBC for two antenna ports (the equation is the same as above but the antenna ports are now provided by different cells),

$$[ \begin{matrix}{y}^{( 0 )} ( 2 i ) \\ {y}^{( 1 )} ( 2 i ) \\ {y}^{( 0 )} ( 2 i + 1 ) \\ {y}^{( 1 )} ( 2 i + 1 )\end{matrix} ] = \frac{1}{\sqrt{2}} [ \begin{matrix}1 & 0 & j & 0 \\ 0 & - 1 & 0 & j \\ 0 & 1 & 0 & j \\ 1 & 0 & - j & 0\end{matrix} ] [ \begin{matrix}Re ( {x}^{( 0 )} ( i ) ) \\ Re ( {x}^{( 1 )} ( i ) ) \\ Im ( {x}^{( 0 )} ( i ) ) \\ Im ( {x}^{( 1 )} ( i ) )\end{matrix} ]$$

Then a suitable combination of joint transmit diversity and beamforming could be achieved if the symbols y⁽⁰⁾(i) and y⁽¹⁾(i) are symbols transmitted by independent beams from each of the two cells, and x⁽⁰⁾(i) and x⁽¹⁾(i) are complex modulated data symbols, available in both cells.

Thus, beamforming is applied to a set of physical antennas to provide an antenna port. According to embodiments of the invention one set of beamforming weights is applied to the physical antennas of one cell to form an antenna port. Another set of beamforming weights is applied to the physical antennas of a second cell to form a second antenna port. Overlap (some degree of commonality) between the physical antennas of the first and second cells is possible.

Since beamforming is applied, DMRS corresponding to each beam are also transmitted from each cell, in separate resources. Within the framework of LTE, this can be achieved if the DMRS from each beam correspond to different antenna ports in each cell. This then allows each DMRS to be received by the UE, the corresponding channel measurements to be made and the transmitted signal to be demodulated at the UE.

The beams can be formed by any antenna ports in each cell for which suitable channel state information is available.

The mapping between signals on an antenna port and the physical antennas can be illustrated by the following (equation is the same but the antenna ports are now provided by different cells):

$$[ \begin{matrix}{z}^{( p , 0 )} ( i ) \\ {z}^{( p , 1 )} ( i ) \\ ⋮ \\ {z}^{( p , N w - 1 )} ( i )\end{matrix} ] = {y}^{( p )} ( i ) [ \begin{matrix}{w}^{( p , 0 )} ( i ) \\ {w}^{( p , 1 )} ( i ) \\ ⋮ \\ {w}^{( p , N w - 1 )} ( i )\end{matrix} ]$$

Where y^{(p)}(i) is the symbol to be transmitted on an antenna port p, w(i) are the precoding coefficients for each physical antenna for antenna port p, Nw is the number of physical antennas and z(i) are the transmitted symbols from each physical antenna for antenna port p. We are assuming that only a subset of antennas (from one cell) contributes to a given beam.

If each cell can transmit more than one beamformed transmission signal (or provide more than one antenna port), then a suitable transmit diversity scheme may be applied across these beams. For example, for two beams per cell the four port SFBC-TSTD scheme defined in LTE could be used. Alternatively, if it is desired to transmit more data streams (e.g. two) simultaneously, two port SFBC could be applied twice (once for each data stream).

FIG. 4 schematically illustrates the basic arrangement in accordance with the present invention. In this illustration two eNodeBs 101 and 102 each contribute a respective set of antennas for joint transmission to the same UE 20 and consequently, co-ordination between the eNodeBs is required as indicated by the arrow. Transmit diversity is performed with different antenna ports configured for each set of antennas.

Some more specific embodiments of the present invention will now be considered.

In a first embodiment based on LTE, the network operates using FDD and comprises one or more eNodeBs, each controlling one or more downlink cells, each downlink cell having a corresponding uplink cell. Each DL cell may serve one or more terminals (UEs) which may receive and decode signals transmitted in that serving cell. In addition each UE may be configured to have two or more serving cells at the same carrier frequency. In this embodiment all the serving cells for one UE are controlled by the same eNodeB.

In order to control the use of transmission resources in time, frequency and spatial domains for transmission to and from the UEs, the eNodeB sends control channel messages (PDCCH) to the UEs. A PDCCH message typically indicates whether the data transmission will be in the uplink (using PUSCH) or downlink (using PDSCH). It also indicates the transmission resources, and other information such as transmission mode, number of antenna ports, and data rate. In addition PDCCH may indicate which reference signals may be used to derive a phase reference for demodulation of a DL transmission. In order for the eNodeB to schedule efficient transmissions to UEs with appropriate transmission parameters and resources, each UE provides feedback on the DL channel state for one, two or more serving cells to the eNodeB controlling the serving cell(s) for that UE. This channel state feedback information includes a channel quality metric (e.g. CQI) and a preferred precoder in the form of an index to a codebook entry (PMI), and a preferred transmission rank (RI), which is the number of spatial layers. The channel state feedback is based on channel measurements at the UE using

CRS or CSI-RS. In reporting CQI (which is defined in terms of an achievable data rate), the UE bases the estimated CQI on the assumption of a particular data transmission mode, as configured by the eNodeB.

Some channel state information might be available by other means (e.g. if reciprocity can be assumed between uplink and downlink which may be possible in some cases e.g. in TDD), however for FDD feedback is the typical mechanism.

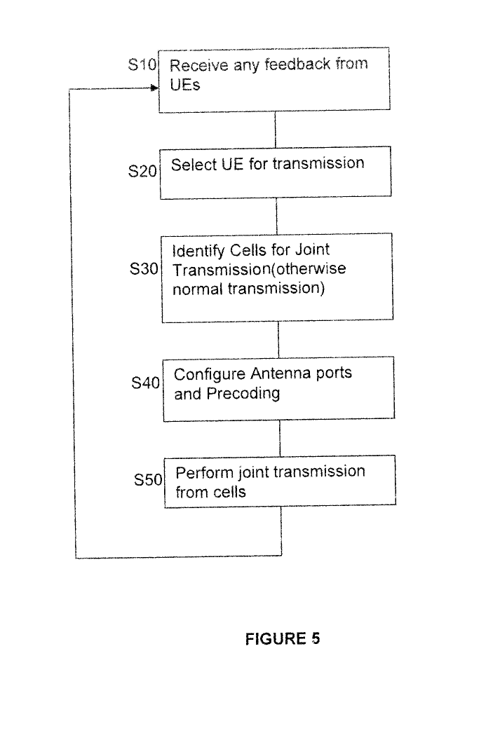

FIG. 5 is a flowchart of steps performed in implementing this embodiment.

In one version of this embodiment, the invention is applied in the DL in the case where the UE is configured with two serving cells at the same frequency. On the basis of the channel state feedback relating to both cells from the UE (step S10), the network first determines a suitable UE for receiving a joint transmission in accordance with the present invention (S20). (Incidentally, references to “the network” here refer mainly to actions or decisions taken at the eNodeB, possibly under supervision of a higher-level node such as a Mobility Management Entity (MME)). The next step (S30) is to identify suitable cells for the joint transmission. If a plurality of suitable cells cannot be found, normal transmission (with the UE served by a single cell) is used, in other words the present invention is not applied.

Assuming however that two or more cells (sets of antennas as already discussed) are available, then the network selects a number of ports and a precoder for each cell (S40). This information is signalled to the UE of interest (e.g. on PDCCH) to assist it in decoding the signal to be jointly-transmitted.

The “precoder” here would normally be one for performing SFBC (for 2 antenna ports) or SFBC-TSTD (for four). In the case where the number of ports is one for both cells, transmit diversity for two antenna ports is applied, with one port supplied by each cell. Corresponding reference signals are transmitted to allow derivation of a phase/amplitude reference for each port at the receiver. This may be by CRS or DMRS.

The joint transmission is then performed from the participating cells (step S50), after which the process returns to the start. Reception of the jointly-transmitted signal by the UE allows the latter to detect the reference signals and provide feedback for each antenna port accordingly as in S10. As channel conditions evolve, steps S10 to S40 are repeated; for example, if a UE moves away from a cell edge closer to the centre of a particular cell, the decision may be taken to revert to normal transmission in step S30.

As a variation of this embodiment in the case where the number of ports is two for both cells, transmit diversity for four antenna ports is applied, with two ports supplied by each cell.

As a further variation of this embodiment the UE is configured with four serving cells at the same frequency and the number of ports is one for each cell, transmit diversity for four antenna ports is applied, with one port supplied by each cell.

As a general variation of this embodiment in the case where N serving cells are configured and the total number of ports is M for all the serving cells (with M>=N), transmit diversity for M antenna ports is applied.

Open loop operation might be possible. For example, precoders which are not optimised for the channel could be used for open-loop transmission (or each of a set of different precoders applied cyclically).

A second embodiment is like the first embodiment except that the serving cells configured for a UE may be controlled by different eNodeBs. In this case channel state feedback is supplied to one of the controlling eNodeBs and control channel messages on PDCCH are received from the same eNodeB. Coordination between eNodeBs is required to exchange channel state information, for scheduling and to implement the transmission joint transmit diversity.

As a variation of the second embodiment, channel state feedback may is supplied to each of the controlling eNodeBs and control channel messages on PDCCH are received from each controlling eNodeB.

In a further variation of this embodiment the control channel messages are transmitted jointly by the controlling eNodeBs.

Third and fourth embodiments are like the first and second embodiments respectively, except that the transmission scheme is not transmit diversity, but spatial multiplexing. Although spatial multiplexing is generally less suitable for transmission to cell edge users, this approach could be used in some channel conditions (such as where the background noise/interference level is low and UE has sufficient antennas to support reception of spatial multiplexing).

As a further variation spatial multiplexing and transmit diversity can be mixed (e.g. with two cells and two ports per cell, two independent transmit diversity transmissions can be formed, each by one port from each cell).

The above description has been mainly on the basis of assumption of a single antenna port used for transmission in each of the co-operating cells. However, the present invention is also applicable in the case of more antenna ports per cell (e.g. 2 or 4). In the case of more antenna ports (where phase references can be derived for each of the antenna ports from their respective sets of reference symbols), transmit diversity schemes such as SFBC (Space-Frequency Block Coding) or STBC (Space-Time Block Coding) can be applied as already mentioned.

Typical transmit diversity techniques require different signals to be sent from each transmit antenna and channel information on the radio path from each transmit antenna to be available at the receiver. Precoding or beamforming could also be used, although this normally requires information on the channel matrix being available at the eNodeB. Another technique, Single Frequency Network (SFN) can be considered as a special case of precoding for transmissions from spatially separated sites. Typically, in SFN the same signal is synchronously transmitted from the different sites (but with no particular precoding, so no channel information is needed). This can be done with one, and in principle, more than one antenna port per site, applying transmit diversity techniques as may be required.

Additional possible variations include the following:—

(a) It is possible to apply the invention to TDD. Although the above explanation has referred to a FDD-based downlink, the principle would apply equally in the case of TDD.
(b) Although reference has been made above to a single UE, of course under practical conditions an eNodeB is in wireless communication with many UEs simultaneously. Under certain conditions it may be possible to apply the method of the invention to a group of such UEs collectively, for example when a number of users are travelling together in the same vehicle.
(c) The above description has referred to joint transmission by one or more base stations on the downlink, and indeed the present invention is primarily aimed at such transmission. However, it may be possible for suitably-equipped subscriber stations in future to co-operate in a similar way to that described above for base stations, with different subscriber stations contributing one or more antenna ports for a joint transmission with transmit diversity on the uplink.
(d) Although it is convenient to regard each set of antennas as being formed by distinct physical antennas, this is not necessarily the case and depending on the eNodeB(s) configuration it would be possible for sets of antennas to share physical antennas. More important is that the sets of antennas provide distinct antenna ports to the UE.

Thus, to summarise, an embodiment of the present invention may provide a scheme for transmission from multiple cells and/or multiple fixed network nodes (eNodeB) to a mobile terminal (UE) in an LTE-Advanced system. The invention is based on the recognition that co-operative transmission from multiple cells can be achieved without inter-cell channel state information if each antenna port is associated with only one cell. Beamforming/precoding can be applied to the physical antennas within a cell, and spatial multiplexing and/or transmit diversity techniques are applied between the cooperating cells. Thus intra-cell beamforming can be used together with inter-cell spatial multiplexing or transmit diversity. In addition, signalling is required to inform the UE which transmission techniques are used.

The features in the different embodiments above may be combined in the same embodiment. Moreover, various modifications are possible within the scope of the present invention.

While the above description has been made with respect to LTE and LTE-A, the present invention may have application to other kinds of wireless communication system also.

Accordingly, references in the claims to “subscriber stations” are intended to cover any kind of subscriber station, mobile terminal and the like and are not restricted to the UE of LTE.

In any of the aspects or embodiments of the invention described above, the various features may be implemented in hardware, or as software modules running on one or more processors. Features of one aspect may be applied to any of the other aspects.

Certain embodiments herein are provided by a computer program or a computer program product for carrying out any of the methods described herein, and a computer readable medium having stored thereon a program for carrying out any of the methods described herein.

A computer program herein may be stored on a non-transitory computer-readable medium, or it may, for example, be in the form of a signal such as a downloadable data signal provided from an Internet website, or it may be in any other form.

It is to be clearly understood that various changes and/or modifications may be made to the particular embodiments just described without departing from the scope of the claims.

### INDUSTRIAL APPLICABILITY

Currently in LTE, at a given carrier frequency a single data channel (PDSCH) is transmitted to the UE from one serving cell (the primary cell or Pcell). At the cell border the Pcell suffers from increased interference from neighbouring cells and typically a lower effective transmission rate is used to increase robustness to interference. Certain embodiments herein achieve co-operative transmission of the data channel by applying beamforming/precoding to the signals transmitted by multiple antennas within one cell to form one or more antenna ports for each cell. Then spatial multiplexing and/or transmit diversity techniques can be applied to the transmissions from the Pcell, in combination at least one other cell. This can be used to improve data channel performance at the cell border.

1. A wireless communication system having:
one or more base stations each having at least one of a plurality of sets of antennas, each set of antennas being capable of serving a distinct geographical area and each set of antennas being capable of being configured for use as a plurality of antenna ports; and
a subscriber station in wireless communication with at least one base station for receiving a data transmission specific to the subscriber station; wherein
said data transmission is jointly transmitted using at least two antenna ports with transmit diversity applied between said at least two antenna ports, and at least two of said at least two antenna ports being configured from different ones of said plurality of sets of antennas.

2. The wireless communication system according to claim 1 wherein each antenna port is associated with a distinct reference signal for reception by the subscriber station.

3. The wireless communication system according to claim 1 wherein at least one said set of antennas corresponds to a cell.

4. The wireless communication system according to claim 3 wherein the subscriber station is in wireless communication with a plurality of cells and the subscriber station is arranged to provide separate feedback for each said cell.

5. The wireless communication system according to claim 3 wherein a plurality of said sets of antenna ports correspond to the same cell.

6. The wireless communication system according to claim 1 wherein the plurality of sets of antennas are provided by the same base station.

7. The wireless communication system according to claim 1 wherein the plurality of sets of antennas are provided by two or more base stations.

8. The wireless communication system according to claim 1 wherein said data transmission includes a plurality of layers each formed by at least two of the antenna ports, different said antenna ports being used for each layer.

9. The wireless communication system according to claim 1 wherein at least one set of antennas is configured for beamforming of the data transmission.

10. The wireless communication system according to claim 1 wherein the system is an LTE-based system, the or each base station is an eNodeB, and said transmit diversity is a transmission mode specified in LTE and/or LTE-A.

11. The wireless communication system according to claim 10 wherein the data transmission specific to the subscriber station is carried on PDSCH of the LTE-based system.

12. The wireless communication system according to claim 10, wherein the reference signal is a CRS or DMRS specified in LTE and/or LTE-A, and wherein each antenna port is associated with a distinct reference signal for reception by the subscriber station.

13. A base station for use in the wireless communication system according to claim 1, the base station configured to provide at least one of said antenna ports for said jointly transmitted data transmission.

14. A subscriber station for use in the wireless communication system according to claim 1, the subscriber station configured to provide feedback on channel quality based on reception of said data transmission from the said at least two antenna ports.

15. A wireless communication method comprising:
providing one or more base stations each having at least one of a plurality of sets of antennas, each set of antennas being serving a distinct geographical area;
configuring the sets of antennas for use as a plurality of antenna ports to perform at least data transmission; and
receiving, at a subscriber station in wireless communication with at least one said base station, a data transmission specific to the subscriber station; wherein
said data transmission is jointly transmitted using at least two of said antenna ports with transmit diversity applied between said at least two antenna ports, and at least two of said at least two antenna ports being configured from different ones of said plurality of sets of antennas.
